(19) United States
(12) Patent Application Publication
(10) Pub. No.: US 2024/0327601 A1
(43) Pub. Date: Oct. 3, 2024

(54) CATALYTIC DEGRADATION OF THERMOSETTING POLYMERS

(71) Applicant: Washington State University, Pullman, WA (US)

(72) Inventors: Jinwen Zhang, Pullman, WA (US); Baoming Zhao, Pullman, WA (US); Wangcheng Liu, Pullman, WA (US); Yiding Cao, Pullman, WA (US); Brian James Bliss, Pullman, WA (US)

(21) Appl. No.: 18/617,962

(22) Filed: Mar. 27, 2024

Related U.S. Application Data
(60) Provisional application No. 63/492,694, filed on Mar. 28, 2023.

(51) Int. Cl. C08J 11/16; B29B 17/02; B29B 17/04; B29K 307/04; B29K 309/08; D01G 11/00

(52) U.S. Cl. CPC C08J 11/16; B29B 17/02; B29B 17/04; D01G 11/00; B29B 2017/0224; B29B 2017/0293; B29K 2307/04; B29K 2309/08; C08J 2363/00; D10B 2101/06; D10B 2101/12

(57) ABSTRACT

Processing facilities, systems, devices, equipment, and associated methods of processing for recycling thermosetting polymers are described herein. In one example, a process includes reacting, under atmospheric pressure, a thermosetting polymer with a catalytic solution containing a solvent having sulfolane and/or a derivative thereof. The reaction converts the thermosetting polymer to polymer fragments dissolvable in the sulfolane and/or the derivative thereof of the catalytic solution. The process then includes causing the polymer fragments to precipitate as solid polymer fragments from the catalytic solution and separating the precipitated polymer fragments from the catalytic solution. As such, the thermosetting polymer can be recycled as the solid polymer fragments.

### CROSS-REFERENCE TO RELATED APPLICATION(S)

This application claims priority to U.S. Provisional Application No. 63/492,694, filed on Mar. 28, 2023, the disclosure of which is incorporated herein by reference in its entirety.

### GOVERNMENT INTERESTS

The technology disclosed herein was supported by the U.S. Department of Energy under grant number DE-EE0008931. The government has certain rights in the disclosed technology.

### BACKGROUND

Thermosetting polymers, or “thermosets,” are widely used in a range of industrial applications due to their unique properties. Examples of thermosetting polymers include resins made from epoxy, polyester, polyurethane, phenols, and melamine formaldehyde. During production, thermosetting polymers can undergo irreversible chemical reactions by curing with, for instance, a curing agent, heat, UV light, etc., resulting in a molecular network structure that may not be easily melted or reshaped. As such, thermosetting polymers can be used as matrix materials in composite structures or materials to provide strength, stiffness, and dimensional stability. These composite structures or materials can be used in automotive, aerospace, industrial machinery, sports equipment, ship building, construction, and other industries. Thermosetting polymers can also be used in adhesives, sealants, electrical/acoustic insulations, molding/casting components, and in many other areas.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Though thermosetting polymers are useful in a range of industrial applications, disposal of used or waste thermosetting polymers presents several challenges due to their unique chemical properties. Unlike thermoplastic polymers, thermosetting polymers cannot be easily melted and reshaped after curing. Thus, used thermosetting polymers cannot be readily reprocessed into new articles through conventional recasting processes. Also, thermosetting polymers do not undergo significant degradation by biodegradation or other natural processes. Once cured, thermosetting polymers remain solid for extended periods that can lead to accumulation of waste in landfills and potentially long-term environmental damage. Furthermore, certain thermosetting polymers, especially those with hazardous additives or curing agents, may emit toxic substances when incinerated. Such emissions can contribute to air pollution and pose risks to human health.

Existing degradation techniques for processing used thermosetting polymers (e.g., a thermoset reinforced with glass fibers) involve reacting in batch mode thermosetting polymers under harsh conditions such as using supercritical fluids, strong acids/alkalis, strong oxidizing agents, molten salts, etc. The batch mode operations can limit scalability of the degradation processes while the harsh conditions can increase processing costs. In addition, the harsh reaction conditions can damage not only the inherent strength of any recovered fibers but also generate undesirable pollutants. Moreover, such harsh reaction conditions can lead to random cleavage of covalent bonds in the processed thermosetting polymers, resulting in oligomers that are difficult to reuse. Instead, selectively cleaving covalent crosslinks of polymer network structures is desirable so that the resulting decomposed matrix polymers (“DMPs”) and any recovered fibers can be readily reused.

Several embodiments of the disclosed technology are directed to processes and associated facilities/equipment for catalytic degradation of used thermosetting polymers and composites thereof using a catalytic solution having a catalyst and a solvent containing sulfolane and/or derivative of sulfolane. Without being bound by theory, the inventors believe that sulfolane and/or derivative thereof can swell molecular network structures of thermosetting polymers during reaction and thus facilitate decomposition of thermosetting polymers into target DMPs under the influence of the catalyst. In certain embodiments, the high boiling points of sulfolane (e.g., approximately 287° C.-289° C.) and derivatives thereof can allow the degradation processes to be carried out under atmospheric pressure. As such, use of pressure vessels can be limited or avoided. In addition, the catalytic solution can be recovered and reused for the next processing cycle. In other embodiments, the degradation processes can be carried out in a pressurized, vacuum, etc. operating in a continuous, semi-continuous, or other suitable modes.

In the following description, a “thermosetting polymer” generally refers to a cured or semi-cured polymer (e.g., epoxy) that undergoes irreversible chemical reactions during curing, resulting in a molecular network structure that may not be easily melted or reshaped after curing. Though the following describes degradation techniques to process an example carbon fiber reinforced polymer, or “CFRP,” in other examples, the embodiments of the degradation technique can be used to process other suitable thermosetting polymers and/or composites thereof containing other reinforcing fibers such as glass fibers or other functional constituents.

In certain embodiments, the degradation process can include an optional pre-processing stage at which a used or waste thermosetting polymer can be physically processed in preparation for a degradation reaction. In one example, the thermosetting polymer can be washed, decreased, cleaned to remove intentional or incidental coating materials such as surface protectant, paint, dirt, etc. In another example, the thermosetting polymer can be cut, shredded, crushed, pulverized, ground, etc., to reduce particle sizes of the thermosetting polymer, or can undergo other suitable physical processing prior to the degradation reaction. In other embodiments, the pre-processing stage or certain operations thereof can be eliminated based on a certain property of the thermosetting polymer.

The degradation process can then include a reaction stage at which the pre-processed thermosetting polymer can be combined with the catalytic solution in a reactor and undergoes a degradation reaction. In one aspect, the catalytic solution can include a solvent containing sulfolane

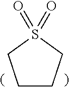

and/or one or more derivatives thereof. In certain embodiments, the derivatives of sulfolane suitable for the degradation reaction can include:

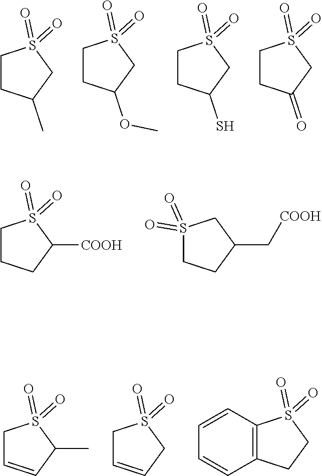

In other embodiments, the solvent can also include other derivatives of sulfolane and/or other solvents having a chemical structure generally similar to or different from that of sulfolane. In some implementations, the weight fraction of sulfolane and/or derivatives thereof is about 0.1% to about 45% by weight, about 20% to about 100% by weight, or about 0.1% to about 3% by weight. In other implementations, the weight fraction of sulfolane and/or derivatives thereof can have other suitable weight fractions depending on the chemical composition of the recycled thermosetting polymer.

The catalytic solution can also include a catalyst that can facilitate ready degradation or dissolution of the thermosetting polymer in the solvent. In one example, the catalyst can include a Lewis acid containing one or more of AlCl₃, CrCl₃, FeCl₃, ZnCl₂, BPh₃, BF₃, BCl₃, B(C₆F₅)₃, B(p-C₆F₄H)₃, [Ph₃C][B(C₆F₅)₄)], [Et₃Si][B(C₆F₅)₄)], AlMe₃, GaCl₃, In(OTf)₃, Sc(OTf)₃, Me₃SiOTf, Al(OTf)₃, or Zn(OTf)₂. In another example, the catalyst can include an organic salt containing a cation such as Al³⁺, Zn²⁺, Fe³⁺, Fe²⁺, Cu²⁺, Cu⁺, Cr³⁺, Cr²⁺, Mn²⁺, Mn³⁺, Co³⁺, Ni²⁺, Ni³⁺, Sn²⁺, Sn⁴⁺, Pb²⁺, and Pb⁴⁺ and an anion such as acetate (CH₃COO⁻), formate (HCOO⁻), propionate (C₂H₅COO⁻), octoate (C₇H₁₅COO⁻), ethanedioate ([C₂O₄]²⁻), or organic sulphonic acid ions. In yet another example, the catalyst can include a Bronsted acid containing one or more of sulfuric acid, nitric acid, hydrochloric acid, phosphoric acid, p-Toluenesulfonic acid, or phosphotungstic acid. In a further example, the catalyst can include a base containing one or more of LiOH, NaOH, KOH, Mg(OH)₂, Ca(OH)₂, guanidine (CH₅N₃), tetramethylammonium hydroxide (N(CH₃)₄OH), or 4-dimethylaminopyridine (C₇H₁₀N₂). In further examples, the catalyst can include other suitable compositions in addition or in lieu of the foregoing substances, or combinations thereof.

In certain embodiments, the degradation reaction of the thermosetting polymer can be carried out at an elevated reaction temperature under atmospheric pressure (e.g., about 14.7 PSIA). In one example, the elevated reaction temperature can be from about 100° C. to about 280° C. In other examples, the elevated reaction temperature can have other values that are lower than the boiling point of sulfolane and/or any derivatives thereof used in the solvent of the catalytic solution. In further embodiments, the degradation reaction can also be carried out under positive pressures (e.g., about 14.8 PSIA to about 147 PSIA) or vacuum (e.g., about 14.0 PSIA to about 1 PSIA) based on a chemical/physical property of the thermosetting polymer.

During operation, the reaction time of the degradation reaction can be set (e.g., as a setpoint in a controller) based on properties of one or more target degradation products (e.g., target DMPs) as a function of the elevated reaction temperature, the chemical/physical properties of the thermosetting polymer, the reaction pressure, or other suitable reaction conditions. For instance, when degrading a CFRP having embedded carbon fibers, the reaction time can be set sufficiently long such that the carbon fibers in the CFRP are readily released from the structural matrix of the CFRP. In another example, the reaction time can be set sufficiently long to cleave cross-linking carbon-nitrogen bonds in the thermosetting polymer such that DMPs having oligomers and/or monomers of target chain lengths can be recovered. In further examples, the reaction time can also be set as a function of other suitable target parameters.

Upon substantial completion of the degradation reaction, the degradation process can include a recovery stage at which the degraded polymer (e.g., DMPs) dissolved in the solvent and/or any fibers initially embedded in the thermosetting polymer can be recovered. For instance, carbon fibers initially embedded in the CFRP can be recovered by filtering the carbon fibers from the catalytic solution. Next, a precipitation agent (e.g., deionized water) can be added to the catalytic solution to cause the degraded polymer to precipitate from the solvent of the catalytic solution. The precipitation of the degraded polymer can then be recovered by filtering and subsequent drying. The catalytic solution with the added precipitation agent can then undergo a regeneration operation (e.g., a flashing or distillation operation) to remove and recover the precipitation agent and the catalytic solution. Both the recovered precipitation agent and catalytic solution can then be reused for the next processing cycle.

Several embodiments of the disclosed technology can allow efficient processing of thermosetting polymers without using severe reaction conditions and/or generating harmful byproducts. Instead, degradation reactions according to aspects of the disclosed technology can be carried out under atmospheric pressure, and thus significantly reduce design and manufacturing complications with using pressure vessels. In another aspect, by suitably controlling the reaction temperature or time, cross-linking carbon-nitrogen bonds of the thermosetting polymer can be selectively cleaved such that the degraded polymer can contain oligomers and/or monomers of target DMPs. In yet another aspect, the degradation process can also be configured as a continuous or semi-continuous process to allow improved scalability when compared to batch-mode processes.

### BRIEF DESCRIPTION OF THE DRAWINGS

FIG. 1 is a flow chart illustrating example processing stages of a degradation process configured in accordance with embodiments of the disclosed technology to catalytically degrade a raw material containing a cured or semi-cured thermosetting polymer.

FIG. 2 is a process flow diagram illustrating an example facility suitable for performing the processing stages in FIG. 1 operating in batch mode in accordance with embodiments of the disclosed technology.

FIG. 3 is a process flow diagram illustrating an example facility suitable for performing the processing stages in FIG. 1 operating in continuous or semi-continuous mode in accordance with embodiments of the disclosed technology.

FIG. 4 is a process flow diagram illustrating another example facility suitable for performing the processing stages in FIG. 1 operating in semi-continuous mode in accordance with embodiments of the disclosed technology.

### DETAILED DESCRIPTION

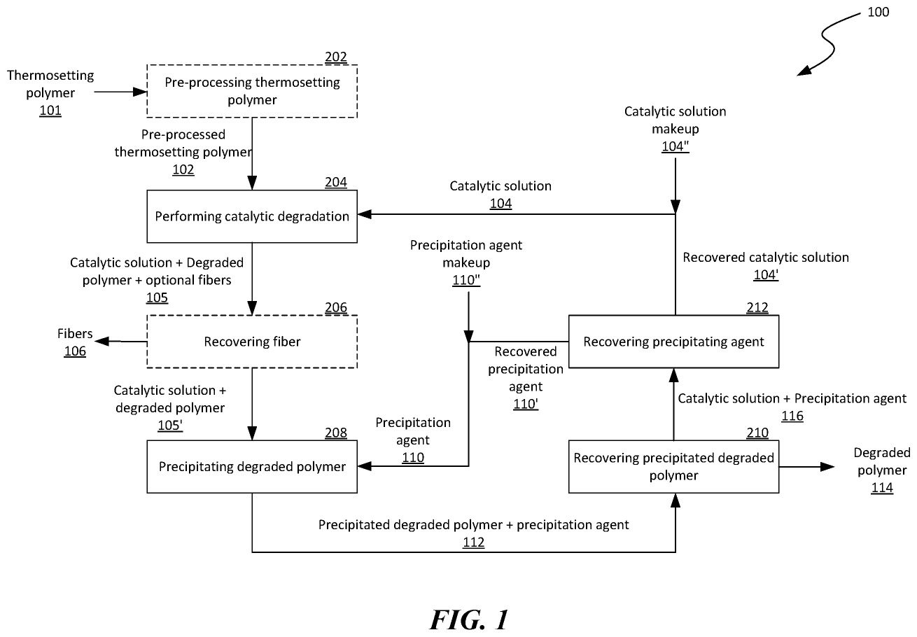

Various embodiments of processing facilities, systems, devices, and associated processes of processing cured or semi-cured thermosetting polymers are described herein. Even though the technology is described below using a CFRP as an example raw material, in other embodiments, the technology may be applicable to process other suitable types of thermosetting polymers such as resins of epoxy, polyester, polyurethane, phenols, and melamine formaldehyde. In the following description, specific details of examples are included to provide a thorough understanding of certain embodiments of the disclosed technology. A person skilled in the relevant art will also understand that the disclosed technology may have additional embodiments or may be practiced without several of the details of the embodiments described below with reference to FIGS. 1-3.

Though thermosetting polymers are useful in a range of industrial applications, disposal of used or waste thermosetting polymers presents challenges due to their unique chemical properties. Existing degradation techniques for processing waste thermosetting polymers (e.g., a thermoset reinforced with glass fibers) involve reacting thermosetting polymers under harsh conditions and operating in batch mode. The existing techniques are not only costly to operate but can also produce products that are difficult to reuse or undesirable pollutants.

Several embodiments of the disclosed technology are directed to processes and associated facilities/equipment for catalytic degradation of waste thermosetting polymers and composites thereof. In one aspect, embodiments of the disclosed technology can utilize a catalytic solution having a catalyst and a solvent containing sulfolane and/or derivative of sulfolane. As the inventors observed through experiments, examples of the catalytic solution can facilitate ready dissolution of cured or semi-cured thermosetting polymers. As such, any embedded fibers in the thermosetting polymer and target DMPs may be efficiently recovered and reused. In another aspect, the degradation processes can also be configured to operate in a continuous or semi-continuous fashion to allow improved scalability when compared to batch-mode processes, as described below with reference to FIGS. 1-3.

FIG. 1 is a flow chart illustrating example processing stages of a degradation process 100 configured in accordance with embodiments of the disclosed technology to catalytically degrade a cured or semi-cured thermosetting polymer 101. As shown in FIG. 1, the degradation process 100 can include an optional pre-processing stage 202 to physically process the thermosetting polymer 101. In one example, the thermosetting polymer 101 can be washed, decreased, cleaned to remove intentional or incidental coating materials such as surface protectant, paint, dirt, etc. In another example, the thermosetting polymer 101 can be cut, shredded, crushed, pulverized, ground, etc., to reduce particle sizes or can undergo other suitable physical processing prior to the degradation reaction. In other embodiments, the pre-processing stage 202 or certain operations thereof can be eliminated.

The degradation process 100 can then include a reaction stage 204 at which the pre-processed thermosetting polymer 102 can be combined with a catalytic solution 104 to undergo a degradation reaction. In one aspect, the catalytic solution 104 can include a solvent containing sulfolane

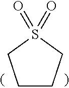

and/or one or more derivatives thereof. In certain embodiments, the derivatives of sulfolane suitable for the degradation reaction can include:

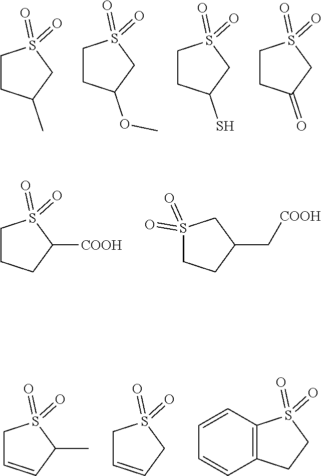

In other embodiments, the solvent can also include other derivatives of sulfolane or other solvents having a chemical structure generally similar to or different from that of sulfolane. In certain examples, the weight fraction of sulfolane and/or derivatives thereof in the catalytic solution 104 is about 0.1% to about 45% by weight, about 20% to about 100% by weight, or about 0.1% to about 3% by weight. In other examples, the weight fraction of sulfolane and/or derivatives thereof in the catalytic solution 104 can have other suitable weight fractions depending on the chemical composition of the recycled thermosetting polymer 101.

The catalytic solution 104 can also include a catalyst that can facilitate ready degradation or dissolution of the thermosetting polymer 101. In one example, the catalyst can include a Lewis acid containing one or more of AlCl₃, CrCl₃, FeCl₃, ZnCl₂, BPh₃, BF₃, BCl₃, B(C₆F₅)₃, B(p-C₆F₄H)₃, [Ph₃C][B(C₆F₅)₄)], [Et₃Si][B(C₆F₅)₄)], AlMe₃, GaCl₃, In(OTf)₃, Sc(OTf)₃, Me₃SiOTf, Al(OTf)₃, or Zn(OTf)₂. In another example, the catalyst can include an organic salt containing a cation such as Al³⁺, Zn²⁺, Fe³⁺, Fe²⁺, Cu²⁺, Cu⁺, Cr³⁺, Cr²⁺, Mn²⁺, Mn³⁺, Co³⁺, Ni²⁺, Ni³⁺, Sn²⁺, Sn⁴⁺, Pb²⁺, and Pb⁴⁺ and an anion such as acetate (CH₃COO⁻), formate (HCOO⁻), propionate (C₂H₅COO⁻), octoate (C₇H₁₅COO⁻), ethanedioate ([C₂O₄]²⁻), or organic sulphonic acid ions. In yet another example, the catalyst can include a Bronsted acid containing one or more of sulfuric acid, nitric acid, hydrochloric acid, phosphoric acid, p-Toluenesulfonic acid, or phosphotungstic acid. In a further example, the catalyst can include a base containing one or more of LiOH, NaOH, KOH, Mg(OH)₂, Ca(OH)₂, guanidine (CH₅N₃), tetramethylammonium hydroxide (N(CH₃)₄OH), or 4-dimethylaminopyridine (C₇H₁₀N₂). In further examples, the catalyst can include other suitable compositions in addition or in lieu of the foregoing substances, or combinations thereof.

In certain embodiments, the degradation reaction of the thermosetting polymer 101 can be conducted at an elevated reaction temperature under atmospheric pressure (e.g., about 14.7 PSIA). In one example, the elevated reaction temperature can be from about 100° C. to about 280° C. In other examples, the elevated reaction temperature can have other values that are lower than the boiling point of sulfolane and/or any derivatives thereof used in the solvent of the catalytic solution 104. In other embodiments, the degradation reaction can also be conducted under positive pressures (e.g., about 14.8 PSIA to about 147 PSIA) or vacuum (e.g., about 14.0 PSIA to about 1 PSIA).

During operation, the reaction time of the degradation reaction can be set based on one or more recycling target materials as a function of the elevated temperature, the chemical/physical properties of the thermosetting polymer, the reaction pressure, or other suitable reaction conditions. For instance, when degrading a CFRP, the reaction time can be set to sufficiently long such that the carbon fibers in the CFRP can be released from the structural matrix of the CFRP. In another example, the reaction time can be set to sufficiently cleave cross-linking carbon-nitrogen bonds in the thermosetting polymer such that DMPs having oligomers and/or monomers of target chain lengths can be recovered. In further examples, the reaction time can also be set as a function of other suitable target parameters.

Without being bound by theory, the inventors believe that sulfolane and/or derivative thereof can swell molecular networks of the thermosetting polymer 101 under the influence of the catalyst and thus facilitate decomposition of the thermosetting polymer 101 into a reaction product 105 with a degraded polymer (e.g., DMPs) and any fibers 106 initially embedded in the thermosetting polymer 101 in the catalytic solution 104. Thus, as shown in FIG. 1, in certain embodiments, the degradation process 100 can include an optional fiber recovering stage 206 at which any released fibers 106 can be recovered by, for instance, filtering the reaction product 105. The recovered fibers 106 can then be dried or otherwise processed for reuse. After recovering the fibers 106, the reaction product 105′ contains only the degraded polymer 108 in the catalytic solution 104. In other embodiments, the fiber recovering stage 206 may be omitted when, for instance, the thermosetting polymer 101 does not include any embedded fibers 106.

In certain embodiments, the degradation process 100 can be configured to recover the degraded polymer and the catalytic solution 104 for reuse. For example, as shown in FIG. 1, the degradation process 100 can include a precipitation stage 208 at which the degraded polymer is precipitated from the catalytic solution 104 by, for instance, adding a precipitation agent 110. In one implementation, the precipitation agent 110 can include deionized water. In other implementations, the precipitation agent 110 can include other suitable compositions. As such, upon contact with the precipitation agent 110, the degraded polymer would precipitate from the catalytic solution 104 to form a precipitated slurry 112 having the precipitation of the degraded polymer and the precipitation agent 110. The degradation process 100 can then include a polymer recovery stage 210 at which the precipitation of the degraded polymer 114 is removed by, for instance, filtering, from an output solution 116 containing the catalytic solution 104 and the precipitation agent 110.

The catalytic solution 104 with the added precipitation agent 110 can then undergo a regeneration operation (e.g., a flashing or distillation operation) at stage 212 to remove and recover the precipitation agent 110′ and the catalytic solution 104′. Both the recovered precipitation agent 110′ and catalytic solution 104′ can then be reused for the next processing cycle with optionally added precipitation agent makeup 110″ and catalytic solution makeup 104″ at stages 208 and 204, respectively.

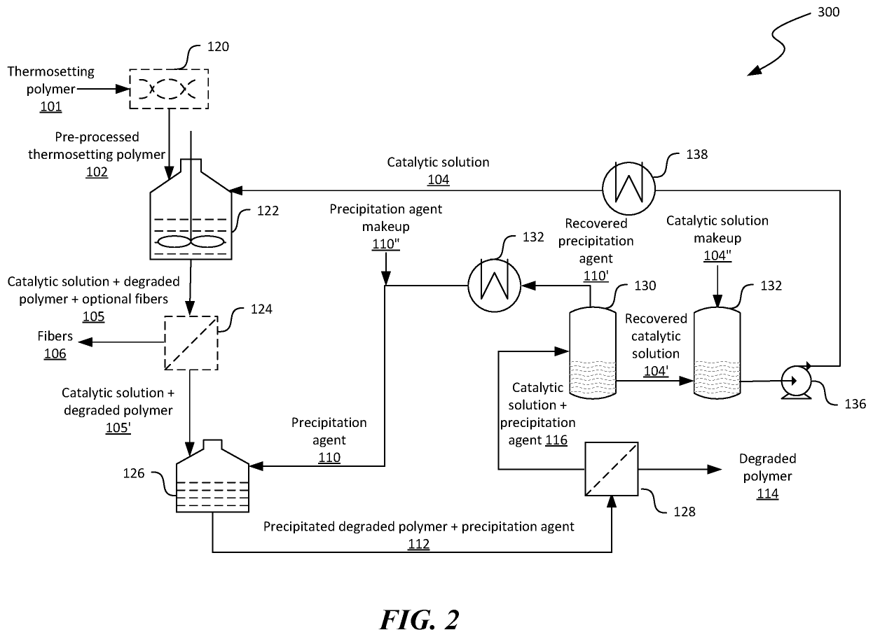

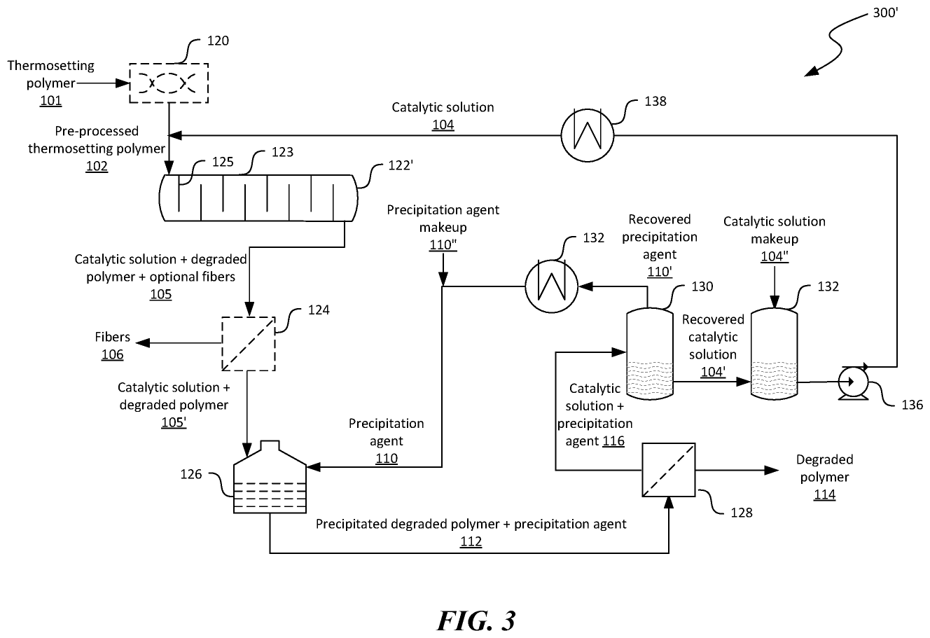

Several embodiments of the degradation process 100 above can allow efficient processing of the thermosetting polymer 101 without using severe reaction conditions and/or generating harmful byproducts. Instead, degradation reactions according to aspects of the disclosed technology can be conducted under atmospheric pressure, for instance, at stage 204, and thus significantly reduce design and manufacturing complications with using pressure vessels. In another aspect, by suitably controlling the reaction temperature or time at stage 204, cross-linking carbon-nitrogen bonds of the thermosetting polymer 101 can be selectively cleaved such that the degraded polymer 114 can contain oligomers and/or monomers of target DMPs. In yet another aspect, the degradation process 100 can also be configured as a continuous or semi-continuous process to allow improved scalability when compared to batch-mode processes, as discussed in more detail below with reference to FIGS. 2 and 3.

FIG. 2 is a process flow diagram illustrating an example facility 300 suitable for performing the processing stages 202-212 in FIG. 1 operating in batch mode in accordance with embodiments of the disclosed technology. As shown in FIG. 2, the facility 300 can include optional pre-processing equipment 120, a reactor 122, an optional fiber filter 124, a precipitation vessel 126, a polymer filter 128, a separator 130, a reservoir 132, and a recirculation pump 136 operative coupled together. Though particular unit operations are shown in FIG. 2 for illustration purposes, in other implementations, additional and/or different unit operations may be utilized to perform operations at the individual stages 202-212. In addition, in certain implementations, the facility 300 can include additional types of equipment such as instrumentation, control systems, gauges, fire arresters, or other suitable devices.

As shown in FIG. 2, the facility 120 can include optional pre-processing equipment 120 configured to receive the thermosetting polymer 101 and physically process the thermosetting polymer 101 into pre-processed thermosetting polymer 102 in preparation for the degradation reaction. In the illustrated embodiment, the pre-processing equipment 122 includes as a shredder. In other embodiments, the pre-processing equipment 122 can include one or more of a washer, a degreaser, a cutter, a crusher, a pulverizer, a grinder, or other suitable types of processing equipment. In further embodiments, the pre-processing equipment 120 may be omitted.

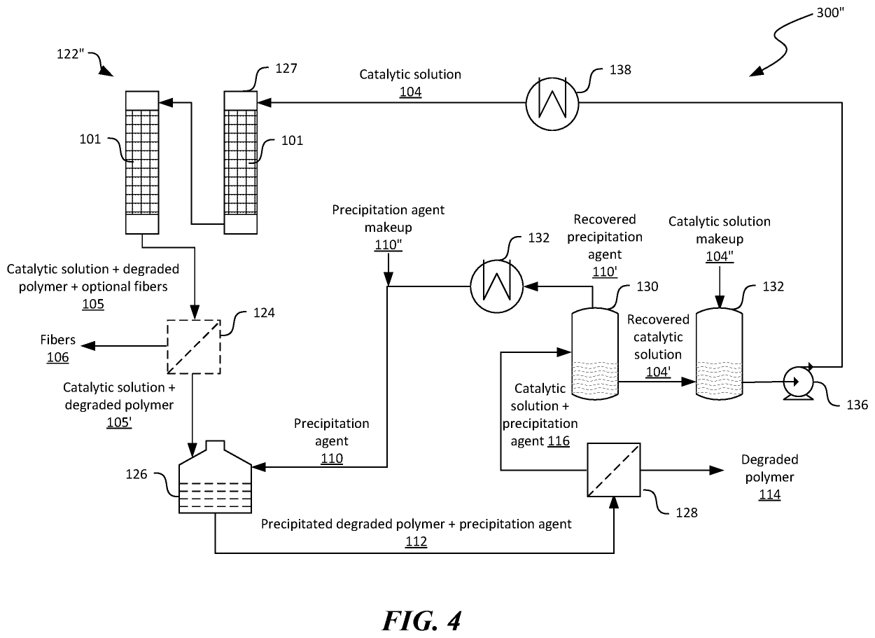

As shown in FIG. 2, the pre-processing equipment 120 is operatively coupled to the reactor 122 that is configured to receive the pre-processed thermosetting polymer 102 from the pre-processing equipment 120 and combine with a catalytic solution 104 before undergoing a degradation reaction. In the illustrated example, the reactor 122 includes a constantly stirred tank reactor (“CSTR”) operating in batch mode. For instance, the pre-processed thermosetting polymer 102 can be combined with the catalytic solution 104 in the reactor 122 and heated to a reaction temperature (e.g., about 100° C. to a temperature below a boiling point of the solvent in the catalytic solution 104) using a heater (not shown). The reactor 122 can then maintain the reaction temperature of the mixture for a period (i.e., reaction time). Both the reaction temperature and the reaction time can be modulated to achieve a target result, as described in more detail above with reference to FIG. 1. In other examples, the reactor 122 can include a plug-flow reactor, as discussed with reference to FIG. 3, a packed bed reactor, as described with reference to FIG. 4, or other suitable types of reactors.

In the illustrated embodiment in FIG. 2, the optional fiber filter 124 can be configured to recover any fibers initially embedded in the thermosetting polymer 101 from the reaction product 105. The fiber filter 124 can include a rotary drum filter, vacuum drum filter, disc filter, or other suitable types of filters. In other embodiments, the fiber filter 124 can be omitted. The remaining reaction product 105′ can then be fed into a precipitation vessel 126 in which the reaction product 105′ is contacted with the precipitation agent 110 to generate a precipitated slurry 112 having the precipitation of the degraded polymer 114 and the precipitation agent 110 in the catalytic solution 104.

The facility 300 can then include the polymer filter 128 configured to remove the precipitation of the degraded polymer 114 from the precipitated slurry 112. The polymer filter 128 can be of the same type as the fiber filter 124 or can be of a different type. The catalytic solution 104 with the added precipitation agent 110 can then be fed into the separator 130 (e.g., a flash drum or distillation column) to be separated into recovered catalytic solution 104′ and recovered precipitation agent 110′. A condenser 132 (e.g., a coil condenser) can then condense the vapor of the recovered precipitation agent 110′ before the precipitation agent 110 is reverted to the precipitation vessel 126.

As shown in FIG. 2, the reservoir 132 can be configured to receive and store the recovered catalytic solution 104′ from the separator 130. In certain implementations, levels of the catalytic solution 104 in the reservoir 132 can be maintained by adding catalytic solution makeup 104″ as needed, periodically, or in other suitable fashions. The recirculation pump 136 (e.g., a centrifugal pump) can be configured to move a flow of the catalytic solution 104 from the reservoir 132 to the reactor 122 via a preheater 138. The preheater 138 can include a tube-in-shell, plate-in-frame, or other suitable types of heat exchanger that is configured to increase a temperature of the catalytic solution 104 from the reservoir 132 to a temperature that at least approximates the reaction temperature in the reactor 122.

FIG. 3 is a process flow diagram illustrating an example facility 300′ suitable for performing the processing stages in FIG. 1 operating in continuous or semi-continuous mode in accordance with embodiments of the disclosed technology. As shown in FIG. 3, the facility 300′ can include certain unit operations generally similar to those shown in FIG. 2 except that the facility 300′ includes a plug-flow reactor 122′ that is configured to operate in a continuous or semi-continuous mode. As shown in FIG. 3, the plug-flow reactor 122′ can include a shell 123 that houses a plurality of baffles 125. The baffles 125 are configured to create a tortuous path through the plug-flow reactor 122′. In certain embodiments, the plug-flow reactor 122′ can be operated in a continuous mode by having sufficient residence time based on a flow rate of the catalytic solution 104. In other embodiments, the plug-flow reactor 122′ can be operated in a semi-continuous mode by, for instance, holding a volume of the catalytic solution 104 combined with the thermosetting polymer 102 for a period before discharging the reaction product 105 to the optional fiber filter 124. As such, by operating in continuous or semi-continuous mode, processing of the thermosetting polymer 101 can be readily scaled up when compared to operating in batch mode.

FIG. 4 is a process flow diagram illustrating another example facility 300″ suitable for performing the processing stages in FIG. 1 operating in semi-continuous mode in accordance with embodiments of the disclosed technology. As shown in FIG. 4, the facility 300″ can include certain unit operations generally similar to those shown in FIG. 2 except that the facility 300″ includes a packed-bed reactor 122″ that is configured to operate in a semi-continuous mode. As shown in FIG. 4, the packed-bed reactor 122″ can include a column 127 that houses the thermosetting polymer 101 inside the column 127 as a packing material through which the catalytic solution 104 can flow. Though not shown in FIG. 4, the packed-bed reactor 122″ can also include heat exchangers or heating coils, pressure control systems, and suitable support structures configured to support the thermosetting polymer 101 to ensure the stability of the packed bed during reaction. In the illustrated example, two packed bed reactors 122″ connected in sequence are shown for illustration purposes. In other examples, the facility 300″ can include three, four, or any suitable numbers of individual reactors 122″ connected in series and/or in parallel.

During operation, the catalytic solution 104 is fed into and flows through the packed-bed reactors 122″ in sequence. Upon contacting with the thermosetting polymer 101, at least a portion of the thermosetting polymer 101 is dissolved by the solvent containing sulfolane and/or derivative of sulfolane in the presence of the catalyst during the degradation process. The reaction product 105 is then transferred to the optional fiber filter 124 for further processing as described in more detail above with reference to FIGS. 1 and 2. After a period of degradation reaction, the thermosetting polymer 101 inside the packed-bed reactors 122″ can be substantially exhausted. The processing can then be suspended, and the packed-bed reactors 122″ can be reloaded with another batch of thermosetting polymer 101. The processing can then continue to process the new batch of thermosetting polymer 101.

Experiments were performed to study effects of embodiments of the degradation process using the catalytic solution discussed above. The following provides a summary of the experiments performed and results observed.

Example of chemical degradation of amine-cured epoxy: a degradation reaction was conducted in a flask at atmospheric pressure. 2 grams of aluminum chloride was dissolved in 98 grams of sulfolane. The obtained solution and 50 grams of amine-cured epoxy were directly added into the flask. The temperature of the solution was raised to 230° C. After reacting for four hours, the reaction mixture was added to 500 grams of cold water. The resulting mixture was centrifuged or filtered to collect the solid resin. After removing water by evaporation, the catalyst solution was recovered and can be reused for the next reaction.

Example of chemical degradation of glass fiber reinforced epoxy composite: a degradation reaction was conducted in a flask at atmospheric pressure. 2 grams of ferric chloride was dissolved in 98 grams of sulfolane. The obtained solution and 20 grams of epoxy composite were directly added into the flask. The temperature of the solution was raised to 230° C. After reacting for four hours, the reaction mixture was added to 500 grams of cold water. The resulting mixture was screen filtered to collect the glass fibers. Then, the slurry was centrifuged or filtered to collect the solid resin. After removing water by evaporation, the catalyst solution was recovered and can be reused for the next reaction.

Example of chemical degradation of carbon fiber reinforced epoxy composite: a degradation reaction was conducted in a flask at atmospheric pressure. 24 grams of aluminum chloride was dissolved in 576 grams of sulfolane. The obtained solution and 100 grams of epoxy composite were directly added into the flask. The temperature was raised to 195° C. After reacting for four hours, the reaction mixture was sequentially washed with water. The resulting mixture was screen filtered to collect the carbon fibers. Then, the slurry was centrifuged or filtered to collect the solid resin. After removing water by evaporation, the catalyst solution was recovered and can be reused for the next reaction.

Example of chemical degradation of carbon fiber reinforced epoxy composite: a degradation reaction was conducted in a flask at atmospheric pressure. 4 grams of aluminum chloride was dissolved in 96 grams of 3-methylsulfolane. The obtained solution and 10 grams of epoxy composite were directly added into the flask. The temperature was raised to 200° C. After reacting for five hours, the reaction mixture was sequentially washed with ethanol. The resulting mixture was screen filtered to collect the carbon fibers. Then, the slurry was centrifuged or filtered to collect the solid resin. After removing ethanol by evaporation, the catalyst solution was recovered and can be reused for the next reaction.

From the foregoing, it will be appreciated that specific embodiments of the technology have been described herein for purposes of illustration, but that various modifications may be made without deviating from the disclosure. In addition, many of the elements of one embodiment may be combined with other embodiments in addition to or in lieu of the elements of the other embodiments. Accordingly, the disclosure is not limited except as by the appended claims.

I/We claim:

1. A process of recycling a thermosetting polymer containing a polymer resin and a plurality of fibers embedded in the polymer resin, comprising:
reacting the thermosetting polymer with a catalytic solution containing a catalyst and a solvent having sulfolane and/or a derivative thereof at a reaction temperature above about 100° C. but below a boiling point of the sulfolane and/or the derivative thereof, wherein the catalyst containing one or more of a Lewis acid, an organic salt, a Bronsted acid, or a base;
maintaining the reaction temperature for a sufficient period such that the plurality of fibers are released from the polymer resin and the polymer resin is converted into polymer fragments dissolvable in the sulfolane and/or the derivative thereof of the catalytic solution;
recovering the plurality of fibers from the catalytic solution via filtration;
subsequently, causing the polymer fragments dissolvable in the sulfolane and/or the derivative thereof to precipitate as solid polymer fragments from the catalytic solution; and
recovering the precipitated polymer fragments from the catalytic solution, thereby recycling the thermosetting polymer as the recovered plurality of fibers and the solid polymer fragments.

2. The process of claim 1 wherein reacting the thermosetting polymer with the catalytic solution includes reacting the thermosetting polymer with the catalytic solution under approximately atmospheric pressure.

3. The process of claim 1 wherein causing the polymer fragments dissolvable in the sulfolane and/or the derivative thereof to precipitate includes causing the polymer fragments dissolvable in the sulfolane and/or the derivative thereof to precipitate and recovering the precipitated polymer fragments from the catalytic solution.

4. The process of claim 1 wherein:
causing the polymer fragments dissolvable in the sulfolane and/or the derivative thereof to precipitate includes causing the polymer fragments dissolvable in the sulfolane and/or the derivative thereof to precipitate by adding water to the catalytic solution and recovering the precipitated polymer fragments from the catalytic solution; and
the process further includes:
subsequent to recovering the precipitated polymer fragments from the catalytic solution, removing the water from the catalytic solution via flashing or distillation; and
recycling both the removed water and the catalytic solution with the water removed for next process period.

5. The process of claim 1, further comprising:
prior to reacting the thermosetting polymer with the catalytic solution, physically processing the thermosetting polymer to reduce a particle size of the thermosetting polymer; and
wherein reacting the thermosetting polymer with the catalytic solution includes reacting the thermosetting polymer having the reduced particle size with the catalytic solution.

6. A processing facility for recycling a thermosetting polymer, comprising:
a reactor operatively configured to receive the thermosetting polymer and a catalytic solution containing a catalyst and a solvent having sulfolane and/or a derivative thereof, the reactor being further configured to cause the thermosetting polymer to react with the solvent in presence of the catalyst at a reaction temperature above about 100° C. but below a boiling point of the sulfolane and/or the derivative thereof, thereby converting the thermosetting polymer to polymer fragments dissolvable in the sulfolane and/or the derivative thereof of the catalytic solution;
a precipitation bath operatively coupled to the reactor to receive the catalytic solution with the polymer fragments dissolvable in the sulfolane and/or the derivative thereof of the catalytic solution, wherein the precipitation bath is further configured to add a precipitation agent to the received catalytic solution and the polymer fragments dissolvable in the sulfolane and/or the derivative thereof of the catalytic solution, the precipitation agent causing the polymer fragments to precipitate as solid polymer fragments from the catalytic solution; and
a separator operatively coupled to the precipitation bath to receive the catalytic solution with the solid polymer fragments precipitated from the catalytic solution, the separator being configured to remove the solid polymer fragments from the catalytic solution, thereby recycling the thermosetting polymer as the separated solid polymer fragments.

7. The processing facility of claim 6 wherein:
the thermosetting polymer contains a polymer resin and a plurality of fibers embedded in the polymer resin; and
the reactor is configured to release the plurality of fibers from the polymer resin when converting the thermosetting polymer to polymer fragments dissolvable in the sulfolane and/or the derivative thereof of the catalytic solution; and
the processing facility further includes a filter positioned between the reactor and the precipitation bath, the filter being configured to remove the plurality of fibers from the catalytic solution.

8. The processing facility of claim 7, further comprising:
a flash tank or a distillation column operatively coupled to the separator to receive the catalytic solution with the precipitation agent, the flash tank or distillation column being configured to remove the precipitation agent from the catalytic solution, thereby allowing recycling of both the precipitation agent and the catalytic solution for next operating period.

9. The processing facility of claim 8 wherein the reactor includes a constantly stirred tank reactor that is configured to operate in batch mode, a packed-bed reactor that is configured to operate in semi-continuous mode, or a plug-flow reactor that is configured to operate in a continuous mode.

10. A process of recycling a thermosetting polymer, comprising:
reacting, under approximately atmospheric pressure, the thermosetting polymer with a catalytic solution containing a catalyst and a solvent having sulfolane and/or a derivative thereof at a reaction temperature above about 100° C. but below a boiling point of the sulfolane and/or the derivative thereof, thereby converting the thermosetting polymer in the catalytic solution to polymer fragments dissolvable in the sulfolane and/or the derivative thereof of the catalytic solution;
causing the polymer fragments dissolvable in the sulfolane and/or the derivative thereof to precipitate as solid polymer fragments from the catalytic solution; and
separating the precipitated polymer fragments from the catalytic solution, thereby recycling the thermosetting polymer as the separated solid polymer fragments.

11. The process of claim 10 wherein causing the polymer fragments dissolvable in the sulfolane and/or the derivative thereof to precipitate includes causing the polymer fragments dissolvable in the sulfolane and/or the derivative thereof to precipitate by adding water to the catalytic solution.

12. The process of claim 10 wherein a weight fraction of the sulfolane and/or the derivative thereof in the catalytic solution is about 20% to about 100% by weight.

13. The process of claim 10 wherein a weight fraction of the solvent in the catalytic solution is about 0.1% to about 35% by weight or is about 0.1% to about 3% by weight.

14. The process of claim 10 wherein the catalyst contains one or more of AlCl₃, CrCl₃, FeCl₃, ZnCl₂, BPh₃, BF₃, BCl₃, B(C₆F₅)₃, B(p-C₆F₄H)₃, [Ph₃C][B(C₆F₅)₄)], [Et₃Si][B(C₆F₅)₄)], AlMe₃, GaCl₃, In(OTf)₃, Sc(OTf)₃, Me₃SiOTf, Al(OTf)₃, Zn(OTf)₂.

15. The process of claim 10 wherein the catalyst contains an anion and a cation, wherein the cation is one or more of Al³⁺, Zn²⁺, Fe³⁺, Fe²⁺, Cu²⁺, Cu⁺, Cr³⁺, Cr²⁺, Mn²⁺, Mn³⁺, Co³⁺, Ni²⁺, Ni³⁺, Sn²⁺, Sn⁴⁺, Pb²⁺, or Pb⁴⁺, and wherein the anion is one or more of acetate (CH3COO⁻), formate (HCOO⁻), propionate (C2H5COO⁻), octoate (C₇H₁₅COO⁻), or ethanedioate ([C₂O₄]²⁻).

16. The process of claim 10 wherein the catalyst contains one or more sulfuric acid, nitric acid, hydrochloric acid, phosphoric acid, p-Toluenesulfonic acid, phosphotungstic acid.

17. The process of claim 10 wherein the catalyst contains one or more of LiOH, NaOH, KOH, Mg(OH)₂, Ca(OH)₂, guanidine (CH₅N₃), tetramethylammonium hydroxide (N(CH₃)₄OH), or 4-dimethylaminopyridine (C₇H₁₀N₂).

18. The process of claim 10, further comprising:
prior to reacting the thermosetting polymer with the catalytic solution, physically processing the thermosetting polymer to reduce a particle size of the thermosetting polymer; and
wherein reacting the thermosetting polymer with the catalytic solution includes reacting the thermosetting polymer having the reduced particle size with the catalytic solution.

19. The process of claim 10 wherein the catalyst contains one or more of a Lewis acid, an organic salt, a Bronsted acid, or a base.

20. The process of claim 10 wherein the derivative of sulfolane includes one or more of the following: [chemical structure]
